(19) United States
(12) Patent Application Publication
(10) Pub. No.: US 2020/0057541 A1
(43) Pub. Date: Feb. 20, 2020

(54) DYNAMICALLY GENERATED TASK SHORTCUTS FOR USER INTERACTIONS WITH OPERATING SYSTEM USER INTERFACE ELEMENTS

(71) Applicant: Google LLC, Mountain View, CA (US)

(72) Inventors: Tim Wantland, Bellevue, WA (US); Asela Jeevaka Ranaweera Gunawardana, Seattle, WA (US)

(21) Appl. No.: 16/608,477

(22) PCT Filed: Dec. 22, 2017
(86) PCT No.: PCT/US2017/068272

§ 371 Date: Oct. 25, 2019

(51) Int. Cl. G06F 3/0484; G06F 3/0481; G06F 3/0488; G06F 9/451

(52) U.S. Cl. CPC G06F 3/0484; G06F 9/451; G06F 3/04883; G06F 3/04817

(57) ABSTRACT

A method includes outputting a first graphical user interface including application information associated with a particular application of a plurality of applications executable by the computing device. The method also includes receiving an indication of a user input corresponding to a command associated with an operating system. The method further includes generating, based at least in part on the application information displayed as part of the first graphical user interface, at least one task shortcut to an action performable by one or more respective applications of the plurality of applications executable by the computing device. The method includes outputting a second graphical user interface including a graphical element corresponding to the at least one task shortcut.

### BACKGROUND

Typically, in order to compose an email, obtain directions to a location, or perform another task using a mobile computing device (such as a smartphone), a user must perform several actions, such as launching a relevant application, selecting a particular user interface feature, and selecting a recipient or specify other relevant information, before ultimately accomplishing the desired task. In addition, the user may need to switch from one application to another by selecting an icon to switch applications or navigate to a home page, select the relevant application from a set of applications, and then perform an action within the relevant application. Further, the user must perform each action of the task each time he or she performs the task. Such interactions can be tedious, repetitive, and time consuming.

### SUMMARY

In general, the disclosed subject matter relates to techniques for enabling an operating system to dynamically determine actions associated with an application that a user may want to perform. For example, an operating system of a computing device may determine one or more tasks associated with an application in response to receiving a user input corresponding to a command associated with an operating system of the computing device. As one example, the computing device may display a graphical user interface that includes application information associated with a particular application and graphical elements corresponding to commands associated with the operating system. For example, the graphical user interface may include information (e.g., text and/or images) for an internet browser and graphical elements corresponding to the operating system, such as a back icon, home icon, and application-switching icon (also referred to as a task-switching icon).

The computing device may receive a user input selecting the back icon, home icon, or application-switching icon of a graphical user interface. In response, the operating system may cause the computing device to display a shortcut menu that includes one or more of the predicted tasks that are associated with application information displayed as part of the graphical user interface. The computing device may receive a user input selecting one of the tasks and may then automatically begin performing actions that correspond to the selected task. For example, responsive to receiving a user input selecting a shortcut to book a trip, the operating system may automatically execute a travel agent application and display a user interface for searching flights in which the destination address is prefilled with the destination (e.g., city, airport, etc.) shown in the application information of the earlier graphical user interface.

By predicting tasks that the user might want to perform and displaying respective task shortcuts when receiving a user input indicative of a command associated with the operating system (e.g., commands indicative of a user's intent to change applications), the computing device may enable a user to select an icon associated with a particular task rather than searching for the appropriate application and performing each action of the task. In this way, the techniques may enable the computing device to reduce the number of steps needed to perform a task. Furthermore, the techniques of this disclosure may reduce the number of user inputs required to perform various tasks, which may simplify the user experience and may reduce power consumption of the computing device (given that less user inputs need to be processed, thereby reducing power consumption and potentially improving overall operation of the computing device).

In one example, a method includes outputting, by a computing device and for display at a presence-sensitive display device, a first graphical user interface including application information associated with a particular application of a plurality of applications executable by the computing device. The method includes receiving, by the computing device and from the presence-sensitive display device, an indication of a user input corresponding to a command associated with an operating system. The method also includes responsive to receiving the indication of the user input, generating, by the computing device, based at least in part on the application information displayed as part of the first graphical user interface, at least one task shortcut to an action performable by one or more respective applications of the plurality of applications executable by the computing device. The method further includes outputting, by the computing device, for display by the display device, a second graphical user interface including a graphical element corresponding to the at least one task shortcut.

In another example, a computing device includes one or more processors, a presence-sensitive display device, and a storage device that stores one or more modules. The one or more modules are executable by the one or more processors to output, for display at a presence-sensitive display device, a first graphical user interface including application information associated with a particular application of a plurality of applications executable by the computing device. The one or more modules are executable by the one or more processors to receive, from the presence-sensitive display device, an indication of a user input corresponding to a command associated with an operating system, and responsive to receiving the indication of the user input, generate, based at least in part on the application information displayed as part of the first graphical user interface, at least one task shortcut to an action performable by one or more respective applications of the plurality of applications executable by the computing device. The one or more modules are executable by the one or more processors to output, for display by the display device, a second graphical user interface including a graphical element corresponding to the at least one task shortcut.

In another example, a computer-readable storage medium is encoded with instructions. The instructions, when executed, cause one or more processors of a computing device to output, for display at a presence-sensitive display device, a first graphical user interface including application information associated with a particular application of a plurality of applications executable by the computing device. The instructions, when executed, also cause one or more processors of a computing device to receive, from the presence-sensitive display device, an indication of a user input corresponding to a command associated with an operating system, and responsive to receiving the indication of the user input, generate, based at least in part on the application information displayed as part of the first graphical user interface, at least one task shortcut to an action performable by one or more respective applications of the plurality of applications executable by the computing device. The instructions, when executed, further cause one or more processors of a computing device to output, for display by the display device, a second graphical user interface including a graphical element corresponding to the at least one task shortcut.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A-1C are conceptual diagrams illustrating an example computing device and graphical user interfaces that provides dynamically generated task shortcuts, in accordance with one or more aspects of the present disclosure.

FIG. 2 is a block diagram illustrating an example computing device that is configured to dynamically generate task shortcuts, in accordance with one or more aspects of the present disclosure.

FIGS. 3A-3C are conceptual diagrams illustrating example graphical user interfaces presented by an example computing device that is configured to dynamically generate task shortcuts, in accordance with one or more aspects of the present disclosure.

FIGS. 4A-4B are conceptual diagrams illustrating example graphical user interfaces presented by an example computing device that is configured to dynamically generate task shortcuts, in accordance with one or more aspects of the present disclosure.

FIGS. 5A-5C are conceptual diagrams illustrating example graphical user interfaces presented by an example computing device that is configured to dynamically generate task shortcuts, in accordance with one or more aspects of the present disclosure.

FIG. 6 is a flowchart illustrating example operations performed by an example computing device that is configured to dynamically generate task shortcuts, in accordance with one or more aspects of the present disclosure.

### DETAILED DESCRIPTION

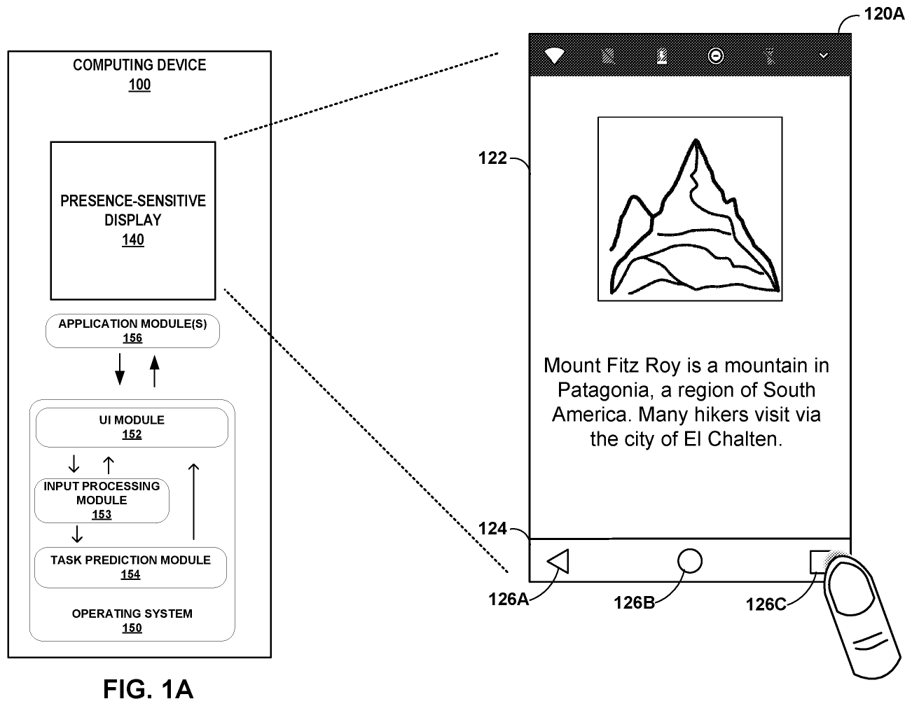

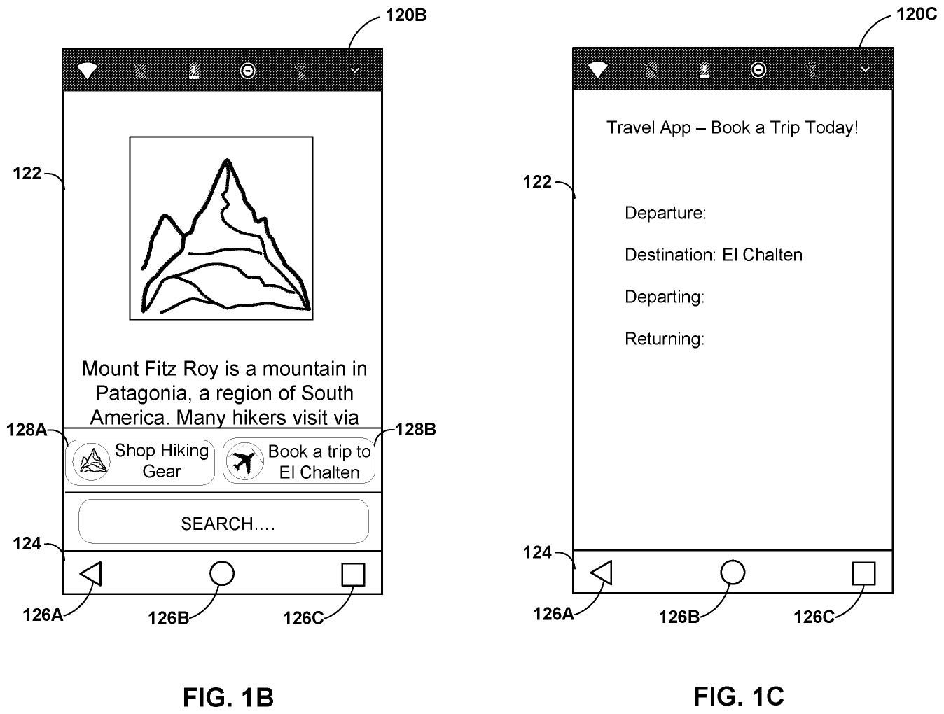

FIGS. 1A-1C are conceptual diagrams illustrating an example computing device 100 and graphical user interfaces 120A-120C that provide dynamically generated task shortcuts, in accordance with one or more aspects of the present disclosure. In the example of FIG. 1A, computing device 100 may include, be, or be a part of, one or more of a variety of types of computing devices, such as mobile phones (including smartphones), tablet computers, netbooks, laptops, personal digital assistants (“PDAs”), desktop computers, wearable computing devices (e.g., watches, eyewear, etc.), e-readers, televisions, automobile navigation and entertainment systems, and/or other types of devices. In other examples, computing device 100 may be one or more processors, e.g., one or more processors of one or more of the computing devices described above.

Computing device 100 includes presence-sensitive display (PSD) 140, which may function as a respective input and/or output device for computing device 100. PSD 140 may be implemented using various technologies. For instance, PSD 140 may function as an input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 140 may also function as an output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 100.

PSD 140 may receive tactile input from a user of respective computing device 100. PSD 140 may detect one or more user inputs (e.g., the user touching or pointing to one or more locations of PSD 140 with a finger or a stylus pen) and output one or more indications (e.g., information describing the location and/or duration of the input) of the user input. PSD 140 may output information to a user as a user interface (e.g., graphical user interface 114, which may be associated with functionality provided by computing device 100. For example, PSD 140 may present various user interfaces related to an application or other features of computing platforms, operating systems, applications, and/or services executing at or accessible from computing device 100.

Computing device 100 includes operating system 150. Operating system 150, in some examples, controls the operation of components of computing device 100. For example, operating system 150, in one example, facilitates the communication of application modules 156 with various run-time libraries and hardware components of computing device 100, such as presence-sensitive display 140. Operating system 150 may also perform various system operations or operations between multiple application modules 156. For instance, in response to receiving a user input, operating system may perform a copy operation, a paste operation, a screenshot operation, a minimize window operation, a terminate active application operation, or a task-switching operation (e.g., swapping the active application).

In this respect, operating system 150 may provide an interface between the underlying hardware of computing device 100 and application modules 156. Operating system 150 may include a kernel that executes in a protected area of memory (which may be referred to as “system memory space”). The kernel may reveal interfaces (such as application programmer interfaces or APIs) including functions that application modules 156 may invoke to interface with the underlying hardware. The kernel may manage interrupts and exceptions related to the underlying hardware, allocate memory for use by application modules 156, and generally support an execution environment that supports execution of application modules 156.

The kernel may allocate the memory and generally maintain the execution environment in a manner that allows for individual ones of application modules 156 to execute separate from other ones of application modules 156 such that failure of one of application modules 156 generally does not impact execution of the other ones of application modules 156. The kernel may allocate the memory for use by application modules 156, creating a so-called “user memory space” or “application memory space” that is separate from the system memory space. The kernel may also provide for various mechanisms to facilitate execution of multiple ones of application modules 156 concurrently, providing context switching and other functionalities to support concurrent execution of the multiple ones of application modules 156. In this way, operating system 150 may provide the execution environment (e.g., the user memory space) in which multiple ones of application modules 156 may independently, and concurrently execute to provide additional services and functionality over that provided by operating system 150.

As further shown in the example of FIG. 1, operating system 150 of computing device 100 may include user interface (UI) module 152, input processing module 153, and task prediction module 154. Computing device 100 may further include one or more application modules 156A-156N (collectively, “application modules 156”). Modules 152, 153, 154, 156 may perform operations described using hardware, hardware and software, hardware and firmware, or any combination therein. Computing device 100 may execute modules 152, 153, 154, 156 with multiple processors or multiple devices. Computing device 100 may execute modules 152, 153, 154, 156 as virtual machines executing on underlying hardware.

Application modules 156 represent various individual applications and services that may be executed by computing device 100. Examples of application modules 156 include a mapping or navigation application, a calendar application, an assistant or prediction engine, a search application, a transportation service application (e.g., a bus or train tracking application), a social media application, a game application, an e-mail application, a messaging application, an Internet browser application, a keyboard application, or any other application that may execute at computing device 100.

UI module 152 of operating system 150 may represent an application programming interface (API) exposed by operating system 150. UI module 152 may represent a module configured to handle user interactions with PSD 140 and other components of computing device 100. In some examples, UI module 152 may cause PSD 140 to display a user interface as a user of computing device 100 views output and/or provides input at PSD 140. For example, one or more of application modules 156 (e.g., an internet browser application module 156A) may call or invoke UI module 152 to present a graphical user interface. For example, UI module 152 may cause PSD 140 to display a graphical user interface associated with internet browser application module 156A, such as graphical user interface 120A of FIG. 1A. For example, UI module 152 may load a frame buffer associated with PSD 140 with information indicative of graphical user interface 120A. PSD 140 may retrieve the information indicative of graphical user interface 120A from the frame buffer and display graphical user interface 120A.

Graphical user interface 120A includes application information region 122 and operating system region 124. Application information region 122 may include application information (e.g., text and/or images) associated with internet browser application module 156A. As illustrated in FIG. 1A, application information region 122 includes an article including an image and text description. Operating system region 124 may include one or more graphical elements corresponding to commands associated with operating system 150 (e.g., as opposed to commands associated with application module 156A). As illustrated in FIG. 1A, operating system region 124 includes a plurality of operating system graphical elements 126A-126C (collectively, “OS graphical elements”). For example, operating system graphical element 126A may include a “back” icon, operating system graphical element 126B may include a “home” icon, and operating system graphical element 126C may include a “task-switching” icon.

In some instances, UI module 152 may output information indicative of a previously displayed graphical user interface to the frame buffer associated with PSD 140 in response to receiving a user input selecting graphical element 126A, output information indicative of a graphical user interface of a home or default graphical user interface to the frame buffer associated with PSD 140 in response to receiving a user input selecting graphical element 126B, or output information indicative of a graphical user interface that includes graphical elements representative of one or more suspended (e.g., recently used but not currently executing) application modules 156 to the frame buffer in response to receiving a user input selecting graphical element 126C.

In contrast to computing devices that require a user to navigate to a different user interface, search for a particular application, and perform one or more actions within the application to complete a task, in accordance with the techniques of this disclosure, computing device 100 may predict one or more tasks the user is likely to perform in response to receiving a user input corresponding to a command associated with the operating system (e.g., a user input selecting a graphical element displayed in operating system region 124).

Operating system 150 may receive an indication of a user input (e.g., a swipe, tap, double tap, tap and hold, etc.) from PSD 140. For example, PSD 140 may detect a user input at a location corresponding to graphical element 126C, and store an indication of the user input (e.g., a centroid location within PSD 140 indicative of the user input, and/or information indicative of the user input, such as a location of the input, duration of the input, amount of pressure detected, etc.) at a location in the system memory space. PSD 140 may next interface with operating system 150 to pass the location of the indication of the user input in the system memory space. Responsive to receiving the location, operating system 150 may issue, to input processing module 153, an interrupt indicating that the indication of the user input stored at the location in the system memory space is available for further processing.

In some examples, input processing module 153 may, responsive to receiving the interrupt, retrieve the indication of the user input from the system memory space, and determine, based on the indication of the user input, that the user input corresponds to a command associated with operating system 150. For instance, input processing module 153 may determine, based on the indication of the user input, that the user input was received at a location of PSD 140 that displays any of graphical elements 126 and corresponds to a command associated with operating system 150. For example, the indication of user input may include an indication of a location of PSD 140 at which the user input was detected, such that input processing module 153 may compare the location of PSD 140 at which the user input was detected to information identifying the locations of one or more graphical elements displayed by PSD 140. For example, input processing module 153 may determine that the user input occurred at a location of PSD 140 that presents information generated by operating system 150 (e.g., rather than information received from application module 156A). In this way, in some examples, input processing module 153 determines the user input selecting graphical element 126C corresponds to a command associated with operating system 150. Responsive to determining that the user input corresponds to a command associated with operating system 150, input processing module 153 may send, to task prediction module 154, a notification indicating a selection of graphical element 126C.

Responsive to receiving the notification indicating a selection of graphical element 126C, task prediction module 154 may determine or predict one or more tasks the user is likely to perform. Task prediction module 154 may determine a task the user is likely to perform based at least in part on application information displayed as part of graphical user interface 120A. In some scenarios, task prediction module 154 may determine that graphical user interface 120A includes an image of Mount Fitz Roy and text describing activities (e.g., hiking) related to Mount Fitz Roy. For example, responsive to determining that graphical user interface 120A includes an image of Mount Fitz Roy, task prediction module 154 may predict the user is likely to book a trip and may determine one or more task shortcuts to assist the user in performing the task to book the trip. Similarly, task prediction module 154 may predict the user is likely to search for more information about activities (e.g., hiking) described in the application information displayed by PSD 140.

Task prediction module 154 may generate one or more task shortcuts for one or more actions performable by a respective application module of application modules 156 based at least in part on the predicted tasks and the application information displayed as part of graphical user interface 120A. In other words, task prediction module 154 may determine one or more task shortcuts based at least in part on the application information displayed as part of graphical user interface 120A. In some examples, task prediction module 154 may determine the one or more task shortcuts by identifying an application configured to perform the task and determining one or more parameters (e.g., information displayed as part of graphical user interface 120A) to send to the application.

Task prediction module 154 may determine one or more application modules 156 to perform the predicted task. One or more application modules of application modules 156 may register (e.g., in an application file) a set of one or more tasks the respective application module is configured to perform. Task prediction module 154 may determine one or more applications that are configured to perform the predicted task based on the task registration. For example, task prediction module 154 may determine that a travel agent application module 156B is configured to book a trip, and a shopping application module 156C is configured to search for and purchase goods.

Task prediction module 154 may also predict one or more parameters of the task shortcut. As used throughout this disclosure, a task shortcut parameter refers to a specific portion of information to be supplied to a predicted application to perform the predicted task. For example, responsive to determining a predicted task includes booking a trip, task prediction module 154 may determine one or more task shortcut parameters, such as an origin and/or destination of the trip. Similarly, responsive to determining a predicted task includes shopping, task prediction module 154 may determine a task shortcut parameter for shopping, such as a type of item to shop for (e.g., hiking gear).

Responsive to determining one or more applications configured to perform the task and one or more task shortcut parameters, task prediction module 154 may output information about the one or more task shortcuts to UI module 152. For example, task prediction module 154 may output, for one or more predicted tasks, information indicative of the application module configured to perform a predicted task and the task shortcut parameters associated with the predicted task.

UI module 152 may receive the information about the respective task shortcuts and may output information about the task shortcut to a frame buffer associated with PSD 140. For example, UI module 152 may output information indicative of a graphical user interface 120B that includes task shortcut graphical elements 128A and 124B (collectively, task shortcut graphical elements 128) associated with the respective task shortcuts to the frame buffer associated with PSD 140. PSD 140 may receive the information from the frame buffer and may display graphical user interface 120B.

PSD 140 may detect a user input selecting one of task shortcut graphical elements 128, stores information indicative of the user input to a location of the system memory space, and outputs the location of the indication of user input to operating system 150. Operating system 150 may issue an interrupt to input processing module 153, such that input processing module 153 may retrieve the retrieve the indication of the user input from the system memory space. Input processing module 153 may determine the user input corresponds to a selection of a particular task shortcut and output information to UI module 152 indicating a selection of a particular graphical element of graphical elements 126. For example, the indication of user input may include an indication of a location of PSD 140 at which the user input was detected, such that input processing module 153 may compare the location of PSD 140 at which the user input was detected to information identifying the locations of one or more graphical elements displayed by PSD 140. In some examples, input processing module 153 may determine the user input corresponds to a selection of task shortcut graphical element 128B and may output information to UI module 152 indicating the user selected task shortcut graphical element 128B.

Responsive to receiving an indication of the selection of task shortcut graphical element 128B, UI module 152 may execute the application associated with task shortcut graphical element 128B. For example, UI module 152 may execute travel agent application module 156B and may send the task shortcut parameters associated with task shortcut graphical element 128B to travel agent application module 156B. Travel agent application module 156B may send, to UI module 152, information indicative of a graphical user interface 120C associated with travel agent application module 156B. UI module 152 may send the information indicative of graphical user interface 120C to the frame buffer. PSD 140 may retrieve the information indicative of graphical user interface 120C from the frame buffer and display graphical user interface 120C. As illustrated in FIG. 1C, element 128 graphical user interface 120C includes a destination field that is prepopulated based on the application information displayed in graphical user interface 120B. In other words, in some examples, the destination field of graphical user interface 120C is prepopulated with the city “El Chalten.”

Rather than requiring the user to click through several screens, scroll through numerous application icons, and perform additional actions by interacting with a particular application, computing device 100 may predict one or more tasks the user is likely to perform in response to receiving a user input corresponding to a command to perform an operating system command. In this way, computing device may reduce the number of actions performed by the user and the computing device, which may reduce the number of inputs received by the computing device and perform tasks more quickly, thus reducing power consumption and improving battery life.

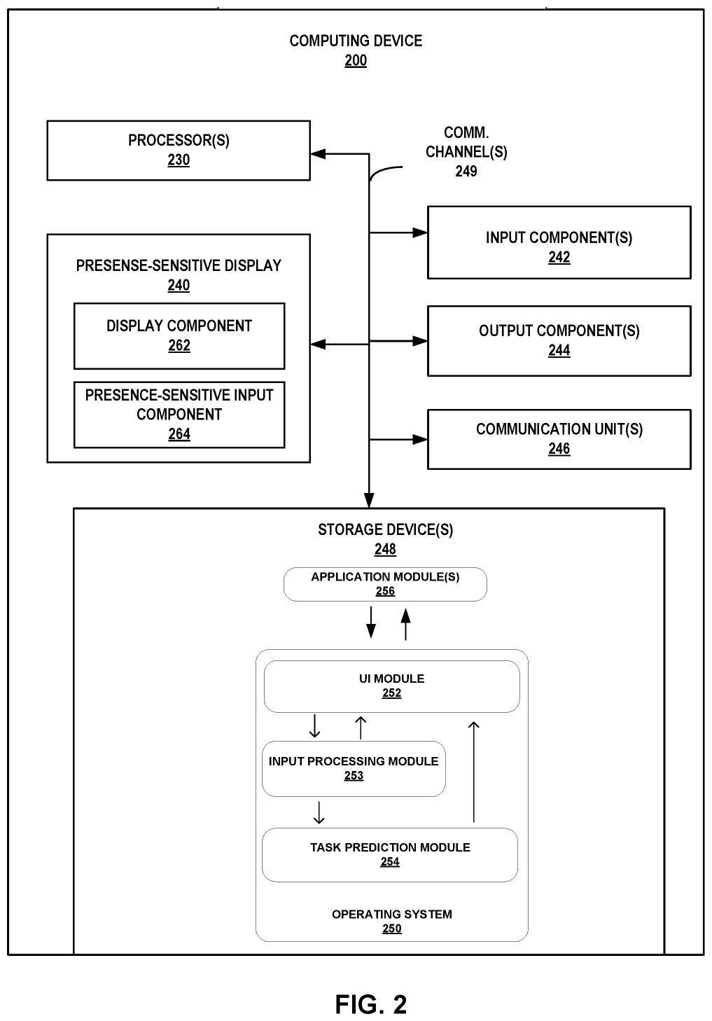

FIG. 2 is a block diagram illustrating an example computing device that is configured to dynamically generate task shortcuts, in accordance with one or more aspects of the present disclosure. Computing device 200 is a more detailed example of computing device 100 of FIG. 1. FIG. 2 illustrates only one particular example of computing device 200, and many other examples of computing device 200 may be used in other instances and may include a subset of the components included in example computing device 200 or may include additional components not shown in FIG. 2.

As shown in the example of FIG. 2, computing device 200 includes one or more processors 230, one or more input components 242, one or more output components 244, one or more communication units 246, one or more storage devices 248, and presence-sensitive display 240. Storage devices 248 of computing device 200 include operating system 250 and one or more application modules 256A-256N (collectively, application modules 256). Communication channels 249 may interconnect each of the components 230, 240, 242, 244, 246, and/or 248 for inter-component communications (physically, communicatively, and/or operatively). In some examples, communication channels 249 may include a system bus, a network connection, one or more inter-process communication data structures, or any other components for communicating data (also referred to as information) between hardware and/or software.

One or more processors 230 may implement functionality and/or execute instructions within computing device 200. For example, processors 230 on computing device 200 may receive and execute instructions stored by storage devices 248 that provide the functionality of operating system 250 and application modules 256. These instructions executed by processors 230 may cause computing device 200 to store and/or modify information, within storage devices 248 during program execution. Processors 230 may execute instructions of operating system 250 and application modules 256 to perform one or more operations. That is, operating system 250 and application modules 256 may be operable by processors 230 to perform various functions described in this disclosure.

One or more input components 242 of computing device 200 may receive input. Examples of input are tactile, audio, kinetic, and optical input, to name only a few examples. Input components 242 of computing device 200, in one example, include a mouse, keyboard, voice responsive system, video camera, buttons, control pad, microphone or any other type of device for detecting input from a human or machine. In some examples, input component 242 may be a presence-sensitive input component, which may include a presence-sensitive screen, touch-sensitive screen, etc.

One or more output components 244 of computing device 200 may generate output. Examples of output are tactile, audio, and video output. Output components 244 of computing device 200, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output.

In some examples, presence-sensitive display 240 of computing device 200 may include functionality of input component 242 and/or output components 244. In the example of FIG. 2, presence-sensitive display 240 may include a presence-sensitive input component 264, such as a presence-sensitive screen or touch-sensitive screen. In some examples, presence-sensitive input component 264 may detect an object at and/or near the presence-sensitive input component. As one example range, presence-sensitive input component 264 may detect an object, such as a finger or stylus that is within two inches or less of presence-sensitive input component 264. Presence-sensitive input component 264 may determine a location (e.g., an (x,y) coordinate) of the presence-sensitive input component at which the object was detected. In another example range, presence-sensitive input component 264 may detect an object two inches or less from presence-sensitive input component 264 and other ranges are also possible. Presence-sensitive input component 264 may determine the location of presence-sensitive input component 264 selected by a user's finger using capacitive, inductive, and/or optical recognition techniques.

In some examples, presence-sensitive display 240 may also provide output to a user using tactile, audio, or video stimuli as described with respect to output component 244. For instance, presence-sensitive display 240 may include display component 262 that presents a graphical user interface. Display component 262 may be any type of output component that provides visual output, such as described with respect to output components 244. While illustrated as an integrated component of computing device 200, presence-sensitive display 240 may, in some examples, be an external component that shares a data or information path with other components of computing device 200 for transmitting and/or receiving input and output. For instance, presence-sensitive display 240 may be a built-in component of computing device 200 located within and physically connected to the external packaging of computing device 200 (e.g., a screen on a mobile phone). In another example, presence-sensitive display 240 may be an external component of computing device 200 located outside and physically separated from the packaging of computing device 200 (e.g., a monitor, a projector, etc. that shares a wired and/or wireless data path with a tablet computer). In some examples, presence-sensitive display 240, when located outside of and physically separated from the packaging of computing device 200, may be implemented by two separate components: a presence-sensitive input component 264 for receiving input and a display component 262 for providing output.

One or more communication units 246 of computing device 200 may communicate with external devices by transmitting and/or receiving data. For example, computing device 200 may use communication units 246 to transmit and/or receive radio signals on a radio network such as a cellular radio network. In some examples, communication units 246 may transmit and/or receive satellite signals on a satellite network such as a Global Positioning System (GPS) network. Examples of communication units 246 include a network interface card (e.g. such as an Ethernet card), an optical transceiver, a radio frequency transceiver, a GPS receiver, or any other type of device that can send and/or receive information. Other examples of communication units 246 may include Bluetooth®, GPS, 3G, 4G, and Wi-Fi® radios found in mobile devices as well as Universal Serial Bus (USB) controllers and the like.

Operating system 250 may control one or more functionalities of computing device 200 and/or components thereof. In the example of FIG. 2, operating system 250 includes user interface (UI) module 252, input processing module 253, and task prediction module 254, which may interact with one or more applications 256 or hardware components of computing device 200, such as PSD 240. In some examples, an application module of application modules 256 may invoke an API of operating system 250, such as UI module 252, in order to cause computing device 200 to output information to a user. For example, internet browser application 256A may invoke UI module 252 to output a graphical user interface that includes application information associated with internet browser application 256A. Responsive to internet browsing application 256A invoking or calling UI module 252, UI module 252 may retrieve the application information from internet browsing application 256A. In some examples, UI module 252 stores graphical user interface information indicative of a graphical user interface (e.g., graphical user interface 120A of FIG. 1) in a frame buffer associated with PSD 240, the graphical user interface information including at least a portion of the application information received from internet browsing application 256A. The graphical user interface information may also include information associated with operating system 150, such as an indication of OS graphical elements 126A-126C of FIG. 1 (e.g., which may indicate a “back” icon, a “home” icon, and a “task-switching” icon). In some examples, PSD 240 retrieves the information indicative of graphical user interface 120A from the frame buffer and displays graphical user interface 120A.

Presence-sensitive input component 264 of PSD 240 may detect a user input and store an indication of the user input at a location of system memory. PSD 240 may send the location of the indication of user input to operating system 250. Input processing module 253 may receive information indicative of the user input (e.g., information indicating a location(s) of the user input, amount of pressure, etc.) from the location of system memory.

In some examples, input processing module 253 determines whether the detected user input corresponds to a command associated with operating system 250. Input processing module 253 may determine whether the input corresponds to an operating system command or an application command based on a type of the user input, a location of the user input, or a combination therein. For example, input processing module 253 may determine whether the type of user input is substantially stationary gesture or a moving gesture based on the indication of user input. For example, the indication of user input may include an indication of the location, speed, amount of pressure, etc. of the user input. Examples of substantially stationary gestures include a tap, a double-tap, a tap and hold, etc.). Examples of moving gestures include a swipe, a pinch, a rotation, etc.

In some examples, input processing module 253 determines the user input corresponds to a command associated with operating system 250 in response to determining the user input is a substantially stationary gesture selecting one of OS graphical elements 126. As another example, input processing module 253 may determine the user input corresponds to an application command in response to determining the user input is a substantially stationary gesture selecting application information displayed within application information region 122 of graphical user interface 120A.

Input processing module 253 may determine that the user input corresponds to a command associated with operating system 250 in response to determining the user input is a moving gesture that traverses PSD 240 from a first predetermined region of PSD 240 to a second predetermined region of PSD 240. For example, input processing module 253 may determine the user input corresponds to an operating system command (e.g. a command to switch tasks, display a home screen, or display a set of suspended applications) in response to determining the user input is a swipe from one side (e.g., the left side) of PSD 240 to another region (e.g., a middle portion) of PSD 240. In some examples, a suspended application refers to a minimized or recently used application that is loaded in memory and is available to execute, but is not currently executing). In another example, input processing module 253 determines that the user input corresponds to an application command in response to determining the user input is a moving gesture that does not begin or end at a predetermined region. For example, input processing module 253 may determine that the user input corresponds to an application command to scroll the application GUI in response to determining that the user input is a moving gesture and that the moving gesture does not begin at a predetermined region of PSD 240.

Responsive to determining that the user input corresponds to a command associated with operating system 250, input processing module 253 may output a notification to task prediction module 254 indicating the user input corresponds to a command associated with operating system 250, such that task prediction module 254 may predict a task the user is likely to perform. In some examples, task prediction module 254 may predict a task the user is likely to perform or analyze information in response to receiving affirmative consent from a user of computing device 200.

Task prediction module 254 may predict one or more tasks the user is likely to perform using by utilizing a model generated by machine learning techniques (e.g., locally on computing device 200) to predict one or more tasks the user is likely to perform. Example machine learning techniques that may be employed to generate a model can include various learning styles, such as supervised learning, unsupervised learning, and semi-supervised learning. Example types of models generated via such techniques include Bayesian models, Clustering models, decision-tree models, regularization models, regression models, instance-based models, artificial neural network models, deep learning models, dimensionality reduction models and the like.

Throughout the disclosure, examples are described where a computing device and/or a computing system analyzes information (e.g., context, locations, speeds, search queries, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain information may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

Task prediction module 254 may determine or predict one or more tasks the user is likely to perform based at least in part on analyzing or identifying application information displayed by PSD 240 as part of graphical user interface 120A. Task prediction module 254 may identify the application information displayed by PSD 240, for example, by performing optical character recognition (OCR) or image recognition on graphical user interface 120A. As another example, task prediction module 254 may identify the application information displayed by PSD 240 by parsing information received from internet browser application module 256A to determine which information is displayed by PSD 240.

In some scenarios, task prediction module 254 predicts a task based at least in part on the application information displayed by PSD 240. For example, task prediction module 254 may determine the user is likely to travel to a destination (e.g., specific address, city, airport, etc.) in response to determining that the application information displayed by PSD 240 includes an address. As another example, task prediction module 254 may determine the user is likely to schedule a calendar entry in response to determining that the application information displayed by PSD 240 includes a date and/or time (e.g., a future date or time).

Task prediction module 254 may determine a task the user is likely to perform based on a context of computing device 200. Task prediction module 254 may collect contextual information associated with computing device 200 to define a context of computing device 200. Task prediction module 254 may be configured to define any type of context that specifies the characteristics of the physical and/or virtual environment of computing device 200 at a particular time.

As used throughout the disclosure, the term “contextual information” is used to describe any information that can be used by task prediction module 254 to define the virtual and/or physical environmental characteristics that a computing device, and the user of the computing device, may experience at a particular time. Examples of contextual information are numerous and may include: time and date information, sensor information obtained by sensors (e.g., position sensors, accelerometers, gyros, barometers, ambient light sensors, proximity sensors, microphones, and any other sensor) of computing device 200, communication information (e.g., text based communications, audible communications, video communications, etc.) sent and received by communication modules of computing device 200, and application usage information associated with applications executing at computing device 200 (e.g., application information associated with applications, Internet search histories, text communications, voice and video communications, calendar information, social media posts and related information, etc.). Further examples of contextual information include signals and information obtained from transmitting devices that are external to computing device 200. For example, task prediction module 254 may receive, via a radio or communication unit of computing device 200, information from one or more computing devices proximate to computing device 200.

Based on contextual information collected by task prediction module 254, task prediction module 254 may define a context of computing device 200 and may determine a task likely to be performed by the user based on the context. In some examples, computing device 200 may include information indicating a home address of a user of computing device 200 (e.g., as part of a user profile) and the context of computing device 200 includes a current location of computing device 200. In these examples, task prediction module 254 may determine the user is likely to book a ride (e.g., via ride-sharing app, or hailing a cab) in response to determining the current location of computing device 200 does not correspond to the user's home city or state (e.g., locations where the user is less likely to have a vehicle). Likewise, task prediction module 254 may determine the user is likely to request traffic information (e.g., travel times via a navigation application) in response to determining the current location of computing device 200 does correspond to the user's home city or state (e.g., locations where the user is more likely to drive a vehicle).

Responsive to determining a task the user is likely to perform, task prediction module 254 may generate one or more task shortcuts. Task prediction module 254 may determine or identify an application configured to perform the task shortcut. In some examples, task prediction module 254 identifies the application based on a data record that associates applications and one or more tasks a given application is configured to perform. For example, application modules 256 may register with operating system 250 a set of one or more tasks the respective application module is configured to perform in a task registration data record (e.g., upon installation of the application). Task prediction module 254 may determine one or more applications that are configured to perform the predicted task based on the task registration data record. For example, task prediction module 254 may determine that navigation application module 256B is configured to present traffic information and ride-sharing application module 256C is configured to book automobile transportation.

In some examples, task prediction module 254 determines or predicts one or more parameters of the task shortcut. Task prediction module 254 may determine the task shortcut parameters based at least in part on the application information displayed by PSD 240. For example, a task parameter for booking a ride may include an origin or destination of the ride. As one example, responsive to determining a predicted task includes booking a ride, task prediction module 254 determine the destination of the ride based on application information displayed by PSD 240, such as an address displayed by PSD 240. Task prediction module 254 may determine one or more parameters of the task shortcut based on contextual information. For example, when the task includes booking a ride, task prediction module 254 may determine the context includes a current location of computing device 200 and may determine the origin of the ride is the current location of computing device 200.

In some examples, task prediction module 254 determines the application configured to perform the task and/or based in part on contextual information. The contextual information may include application usage information. For example, application usage information may indicate the user utilizes a particular ride-sharing application more than another ride-sharing application, such that task prediction module 254 may determine the application configured to perform the task shortcut is the particular ride-sharing application.

Responsive to determining one or more applications configured to perform the task and one or more task shortcut parameters, task prediction module 254 may output information about the one or more task shortcuts to UI module 252. For example, task prediction module 254 may output, for one or more predicted tasks, information indicative of the application module configured to perform the predicted task and the task shortcut parameters associated with the predicted task. In some examples of booking a ride, task prediction module 254 outputs, to UI module 252, information identifying the application ride-sharing application module 256C, information identifying the trip origin as the current location of computing device 200, and information identifying the trip destination as an address displayed by PSD 240.

UI module 252 may receive the information about the respective task shortcuts (e.g., information identifying the application and task parameters) and may output information indicative of one or more task shortcut graphical elements (e.g., an icon) to a frame buffer to be displayed by PSD 240. PSD 240 retrieves the information indicative of the one or more task shortcut graphical elements from the frame buffer and outputs a graphical user interface that includes the one or more task short graphical elements, such as task shortcut graphical elements 128 of FIG. 1B.

PSD 240 may detect a user input selecting a particular task shortcut graphical element (e.g., task shortcut graphical element 128A of FIG. 1B) and output information indicative of the user input. In some examples, input processing module 253 receives the indication of the user input, determines the user input corresponds to a selection of the particular task shortcut, and outputs information to UI module 252 indicating a selection of the particular task shortcut graphical element. For example, input processing module 253 may determine, based on the indication of user input, that the user input corresponds to a selection of a task shortcut graphical element corresponding to booking a ride via a ride-sharing application module 256C. In response, input processing module 253 may output information to UI module 252 indicating the user the selected task shortcut graphical element associated with the task to book a ride.

Responsive to receiving an indication of the selection of the particular task shortcut graphical element, UI module 252 may execute the application module associated with the selected task shortcut graphical element. In some examples, UI module 252 executes ride-sharing application module 256C in response to receiving an indication that the user selected the task shortcut graphical element associated with ride-sharing application module 256C. UI module 252 may output, to ride-sharing application module 256C, the task shortcut parameters associated with the selected task shortcut graphical element.

Ride-sharing application module 256C may receive the task parameters from UI module 252 and generate graphical user interface information based on the received task parameters. For example, the graphical user interface information may include information indicating a trip destination includes the address displayed by PSD 240 and a trip origin includes the current address of computing device 200. UI module 252 may receive the graphical user interface information and send the graphical user interface information to the frame buffer. PSD 240 may retrieve the graphical user interface information from the frame buffer and display a graphical user interface. For example, the graphical user interface may include a trip origin field and a trip destination field that are prepopulated.

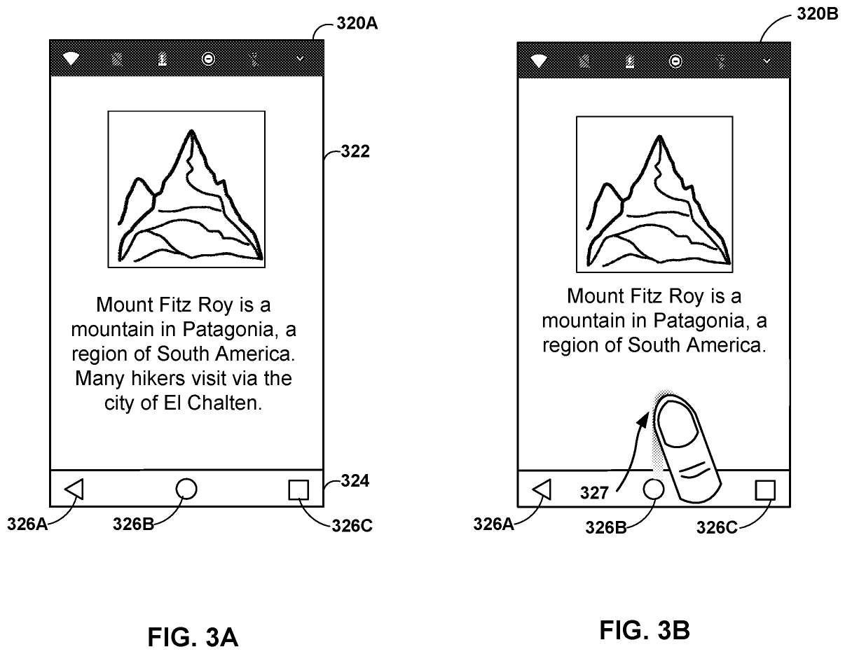

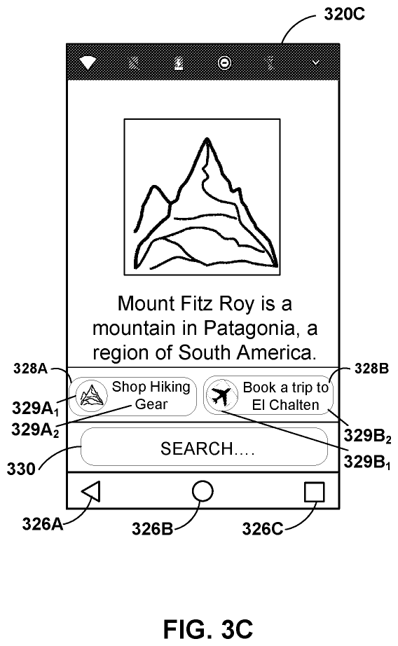

FIGS. 3A-3C are conceptual diagrams illustrating an example graphical user interfaces presented by an example computing device that is configured to dynamically generate task shortcuts, in accordance with one or more aspects of the present disclosure. FIG. 3 are described below in the context of computing device 200 of FIG. 2.

In the example of FIG. 3A, operating system 250 of computing device 200 outputs information corresponding to graphical user interface 320A to a frame buffer associated with PSD 240, such that PSD 240 displays graphical user interface 320A. Graphical user interface 320A includes application information region 322 and operating system region 324. Application information region 322 may include application information (e.g., text and/or images) associated with a particular application, such as internet browser application module 256A. As illustrated in FIG. 1A, application information region 322 includes an article including an image and text description. Operating system region 324 may include one or more graphical elements corresponding to commands associated with operating system 150 (e.g., as opposed to commands associated with application module 156A). As illustrated in FIG. 3A, operating system region 324 includes a plurality of operating system graphical elements 326A-326C (collectively, “OS graphical elements”). In the example of FIG. 3A, operating system graphical element 326A includes a “back” icon, operating system graphical element 326B may includes a “home” icon, and operating system graphical element 326C includes a “task-switching” icon. Responsive to outputting graphical user interface 320A, PSD 240 may detect a user input 327 and may output information (e.g., location, amount of pressure, etc.) indicative of user input 327.

Operating system 250 may receive the information about the user input 327 and determine whether the user input 327 corresponds to a command associated with operating system 250. In some examples, operating system 250 determines whether the user input corresponds to a command associated with operating system 250 based on a type of the user input 327, a location of the user input 327, or a combination therein. Operating system 250 may determine the type and/or location of user input 327 based on the indication of the user input received from PSD 240. For example, operating system 250 may determine the user input corresponds a command associated with operating system 250 in response to determining that user input 327 is a moving gesture and that traverses PSD 240 from a first predetermined region of PSD 240 (e.g., corresponding to an edge of graphical user interface 320B) to a second predetermined region of PSD 240 (e.g., corresponding to an interior region of graphical user interface 320B). In the example of FIG. 3B, operating system 250 determines that user input 327 corresponds to a command associated with operating system 250, such as a command to display a graphical element such as a search box, also referred to as a “Quick Search Bar.”

In some examples, responsive to determining that user input 327 corresponds to a command associated with operating system 250, operating system 250 determines one or more task shortcuts to respective actions performable by one or more respective application modules. For example, operating system 250 may determine one or more tasks the user is likely to perform based at least in part on application information displayed as part of graphical user interface 320B, contextual information, or a combination therein.

Responsive to determining a task the user is likely to perform, operating system 250 may generate one or more task shortcuts. Operating system 250 may generate the one or more task shortcuts by determining or identifying at least one application that is configured to perform the task and one or more task shortcut parameters for the task. For example, responsive to determining a predicted task includes booking a trip, operating system 150 may determine one or more task shortcut parameters, such as a destination of the trip (e.g., El Chalten). Similarly, responsive to determining a predicted task includes shopping, operating system 250 may determine a task shortcut parameter for shopping, such as a type of item to shop for (e.g., hiking gear).

In some examples, operating system 250 outputs information about the task shortcut (e.g., to a frame buffer) such that PSD may output a graphical user interface 320C that includes task shortcut graphical elements 328A and 328B (collectively, task shortcut graphical elements 328) indicative of the predicted task shortcuts. Each task shortcut graphical element may include an indication of the application configured to perform the task and an indication of the predicted task. For example, as illustrated in FIG. 3C, task shortcut graphical element 328A includes a graphical element 329A₁ (e.g., an application icon) indicating the application configured to perform the task and graphical element 329A₂ (e.g., a text description) indicating the task to be performed (e.g., “shop hiking gear”). Likewise, as illustrated in FIG. 3C, task shortcut graphical element 328B includes a graphical element 329B₁ (e.g., an application icon) indicating the application (e.g., a shopping application) configured to perform the task and graphical element 329B₂ (e.g., a text description) indicating the task to be performed (e.g., “Book a trip”). Graphical user interface 320C may also include a graphical element corresponding to the command associated with the operating system, such as search bar graphical element 330.

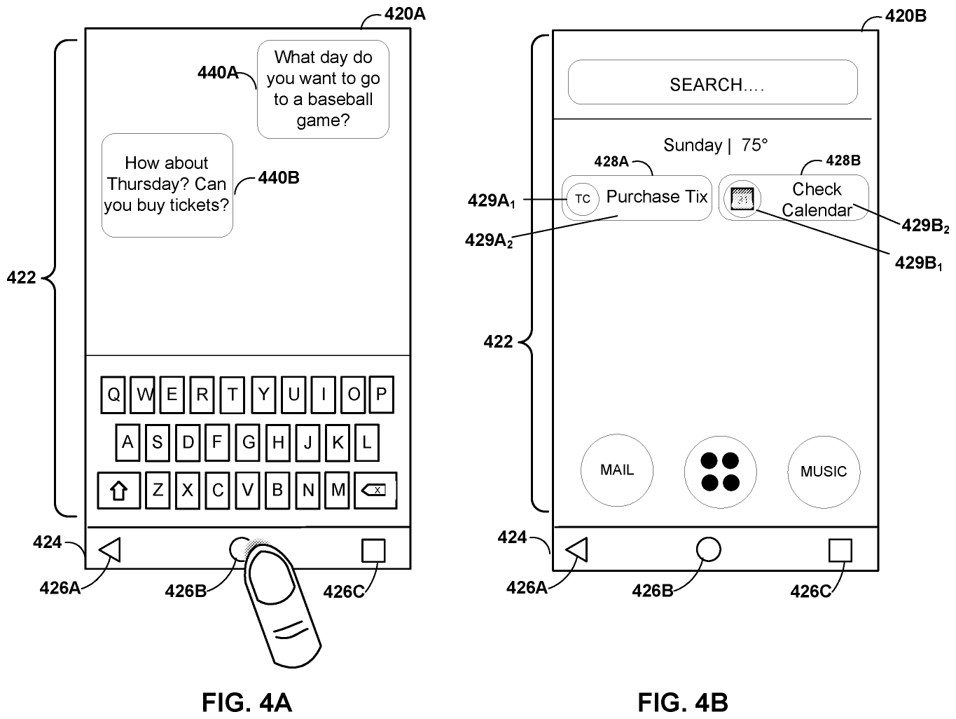

FIGS. 4A-4B are conceptual diagrams illustrating an example graphical user interfaces presented by an example computing device that is configured to dynamically generate task shortcuts, in accordance with one or more aspects of the present disclosure. FIG. 4 is described below in the context of computing device 200 of FIG. 2.

In the example of FIG. 4A, operating system 250 of computing device 200 outputs information corresponding to graphical user interface 420A to a frame buffer, such that PSD 240 displays graphical user interface 420A. Graphical user interface 420A includes application information region 422 and operating system region 424. Application information region 422 may include application information (e.g., text and/or images) associated with a particular application module, such as a messaging application module. In the example of FIG. 4A, application information region 422 includes application information associated with the messaging application, including messages 440A and 440B. Operating system region 424 includes one or more operating system graphical elements 426A-426C that correspond to commands associated with operating system 250. In some examples, operating system graphical element 426A includes a “back icon” indicating of an operating system command to display a previously displayed graphical user interface, operating system graphical element 426B includes a “home icon” indicating of an operating system command to display a home or default graphical user interface for the operating system, and operating system graphical element 426C includes a “task-switching icon” indicating of an operating system command to display a graphical user interface indicative of one or more suspended (e.g., recently used applications).

Responsive to outputting graphical user interface 420A, PSD 240 may detect a user input and may output information (e.g., location, amount of pressure, etc.) about user input. Operating system 250 may receive the information about the user input and determine whether the user input corresponds to a command associated with operating system 250. In some examples, operating system 250 determines whether the user input corresponds to a command associated with operating system 250 based on a type of the user input, a location of the user input, or a combination therein. For example, operating system 250 may determine the user input corresponds a command associated with operating system 250 in response to determining that user input is a substantially stationary gesture located at a position of PSD 240 corresponding to an operating system graphical element (e.g., operating system graphical element 426CB). In other words, operating system 250 may determine the user input corresponds to a command associated with operating system 250 in response to determining the user input is a user input selecting a “home icon”.

In some examples, a user input selecting an operating system graphical element (e.g., a home icon) may indicate the user intends to open or execute a different application (e.g., by selecting the home icon, searching through a set of application icons (e.g., with an app drawer), and selecting an icon for a particular application to launch that application).

Operating system 250 may determine one or more tasks the user is likely to perform in response to determining the user input corresponds to a command associated with operating system 250. In some examples, operating system 250 may determine one or more tasks the user is likely to perform based at least in part on application information displayed as part of graphical user interface 420A, contextual information, or a combination therein. In some examples, operating system 250 may determine the user is likely to purchase tickets to a baseball game and/or view a calendar based on messages 440A and/or 440B. For example, operating system 250 may determine that PSD 240 displays information related to a particular type of sporting event (e.g., baseball game) and that the contextual information includes a user history indicating the user has purchased tickets to the particular type of sporting event in the past.

Responsive to determine a task the user is likely to perform, in some examples, operating system 250 generates one or more task shortcuts. Operating system 250 may generate task shortcuts by determining or identifying at least one application that is configured to perform the task and one or more task shortcut parameters for the task. For example, responsive to determining a predicted task includes booking tickets to a baseball game, operating system 150 may determine one or more task shortcut parameters, such as a date the user would like to attend the game (e.g., Thursday). Similarly, responsive to determining a predicted task includes viewing a calendar, operating system 250 may determine a task shortcut parameter for viewing a calendar, such as particular day or set of days for which to display calendar information.

In some examples, operating system 250 outputs information about the task shortcut (e.g., to a frame buffer) such that PSD may output a graphical user interface 420B that includes task shortcut graphical elements 428A and 428B (collectively, task shortcut graphical elements 428) indicative of the predicted task shortcuts. Each task shortcut graphical element may include an indication of the application configured to perform the task and an indication of the predicted task. For example, as illustrated in FIG. 4B, task shortcut graphical element 428A includes a graphical element 429A₁ (e.g., an application icon) indicating the application configured to perform the task and graphical element 429A₂ (e.g., a text description) indicating the task to be performed (e.g., “Purchase Tix”). Likewise, as illustrated in FIG. 4B, task shortcut graphical element 428B includes a graphical element 429B₁ (e.g., an application icon) indicating the application (e.g., a calendar application) configured to perform the task and graphical element 429B₂ (e.g., a text description) indicating the task to be performed (e.g., “Check Calendar”).

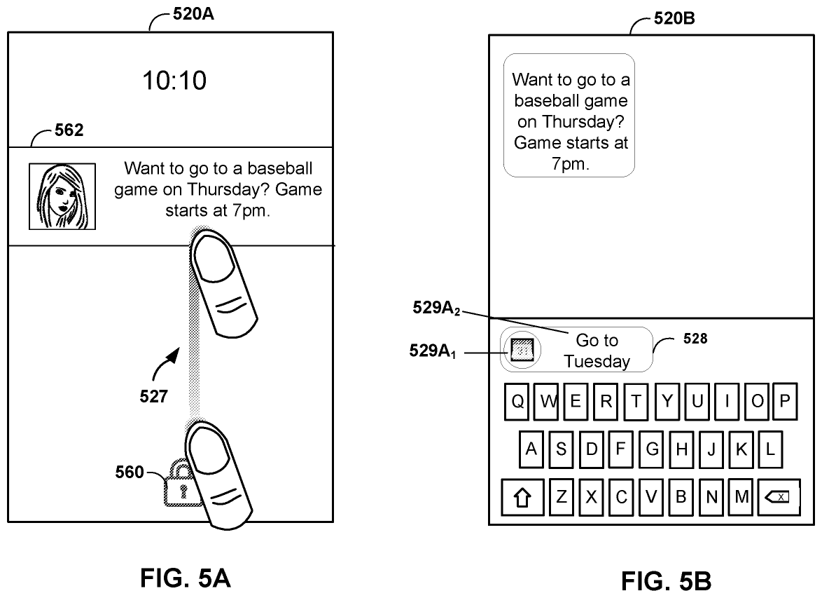

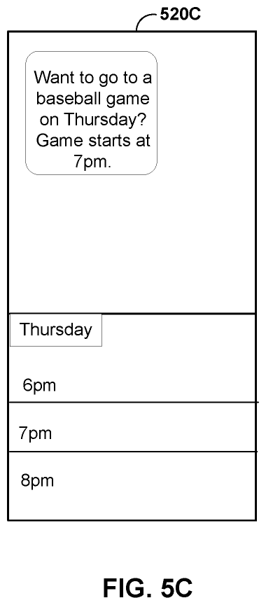

FIGS. 5A-5C are conceptual diagrams illustrating an example graphical user interfaces presented by an example computing device that is configured to dynamically generate task shortcuts, in accordance with one or more aspects of the present disclosure. FIG. 5 is described below in the context of computing device 200 of FIG. 2.

In the example of FIG. 5A, operating system 250 of computing device 200 outputs information corresponding to graphical user interface 520A to a frame buffer, such that PSD 240 displays graphical user interface 520A. Graphical user interface 520A may represent a lock-screen. As illustrated in FIG. 5A, graphical user interface 520A includes a graphical element 560 indicative of a lock-screen (e.g., a lock icon) and a graphical element 562 indicative of application information (e.g., a lock-screen notification associated with a messaging application).

Responsive to outputting graphical user interface 520A, PSD 240 may detect a user input 527 and may output information (e.g., location, amount of pressure, etc.) about user input 527. For example, PSD 240 may detect a user input at a location of PSD 240 corresponding to operating system graphical element 560 and may output an indication of the user input. Operating system 250 may receive the indication of user input and determine whether the user input corresponds to a command associated with operating system 250.

In some examples, operating system 250 determines whether the user input corresponds to a command associated with operating system 250 based on a type of the user input 527, a location of the user input 327, or a combination therein. For example, operating system 250 may determine the user input corresponds a command associated with operating system 250 in response to determining that user input 327 is a moving gesture that traverses PSD 240 from a first predetermined region of PSD 240 (e.g., corresponding to a particular graphical element, such as graphical element 560) to a second predetermined region of PSD 240 (e.g., a region of PSD 240 corresponding to graphical element 562). In the example of FIG. 5B, operating system 250 determines that user input 527 corresponds to a command associated with operating system 250, such as a command to unlock computing device 250).

In some examples, a user input starting at the operating system graphical element 560 (e.g., a lock icon) and terminating at a graphical element 562 associated with an application (e.g., a lock-screen notification) may indicate the user intends to unlock the computing device and open a messaging application associated with graphical element 562.

Operating system 250 may determine one or more task shortcuts in response to determining the user input corresponds to a command associated with operating system 250. In some examples, operating system 250 may determine one or more tasks the user is likely to perform based at least in part on application information displayed as part of graphical user interface 520A, contextual information, or a combination therein. For example, operating system 250 may determine the user is likely to purchase tickets to a baseball game and/or view a calendar based graphical element 562 of graphical user interface 520A.

Responsive to determine a task the user is likely to perform, operating system 250 may determine or identify at least one application that is configured to perform the task and one or more task shortcut parameters for the task. For example, responsive to determining a predicted task includes viewing a calendar, operating system 250 may determine a task shortcut parameter for viewing a calendar, such as particular day or set of days for which to display calendar information.

In some examples, operating system 250 outputs information about the task shortcut (e.g., to a frame buffer) such that PSD may output a graphical user interface 520B that includes task shortcut graphical element 528 indicative of the predicted task shortcuts. Each task shortcut graphical element may include an indication of the application configured to perform the task and an indication of the predicted task. For example, as illustrated in FIG. 4B, task shortcut graphical element 528 includes a graphical element 529A₁ (e.g., an application icon) indicating the application (e.g., a calendar application) configured to perform the task and graphical element 529A₂ (e.g., a text description) indicating the task to be performed (e.g., “Go to Tuesday”).

PSD 240 may detect a user input selecting a task shortcut graphical element 528 and output information indicative of the user input. Operating system 250 may receive the information indicative of the user input and determine the user input corresponds to a selection of task shortcut graphical element 428B. Responsive to determining the user input corresponds to a selectin of task shortcut graphical element 428B, operating system 250 may execute the application module associated with the selected task shortcut graphical element (e.g., a calendar application). In some examples, operating system 250 may output, to the calendar application, the task shortcut parameters associated with the selected task shortcut graphical element. For instance, operating system 250 may output a notification to the calendar application indicating task shortcut parameter includes an action to output calendar information for Tuesday evening.

Responsive to executing the particular application indicated by the task shortcut graphical element 428B, the calendar application may retrieve information (e.g., from a memory device or remote computing device) associated with one or more task shortcut parameters and may output the information to operating system 250. For example, the calendar application may output graphical user interface information indicative of calendar events for the day/time indicated by the task shortcut parameters (e.g., Thursday evening).

Operating system 250 may receive the graphical user interface information and send the graphical user interface information to the frame buffer. Graphical user interface 520C may include application information associated with the application configured to perform the task (e.g., calendar information associated with the calendar application). In some examples, graphical user interface 520C also includes application information associated with the messaging application. In other words, in some examples, operating system 250 may execute the application configured to perform the task shortcut and cause PSD 240 to output a graphical user interface associated with the application configured to perform the task shortcut without terminating or suspending a currently executing application. Said another way, operating system 250 may execute the messaging application and calendar application simultaneously, and output a graphical user interface 520C that includes application information for both the messaging application and calendar application. In this way, the user may view calendar information without switching applications, which may improve the user experience by reducing user inputs. Reducing user inputs may decrease power consumption and increase battery life.

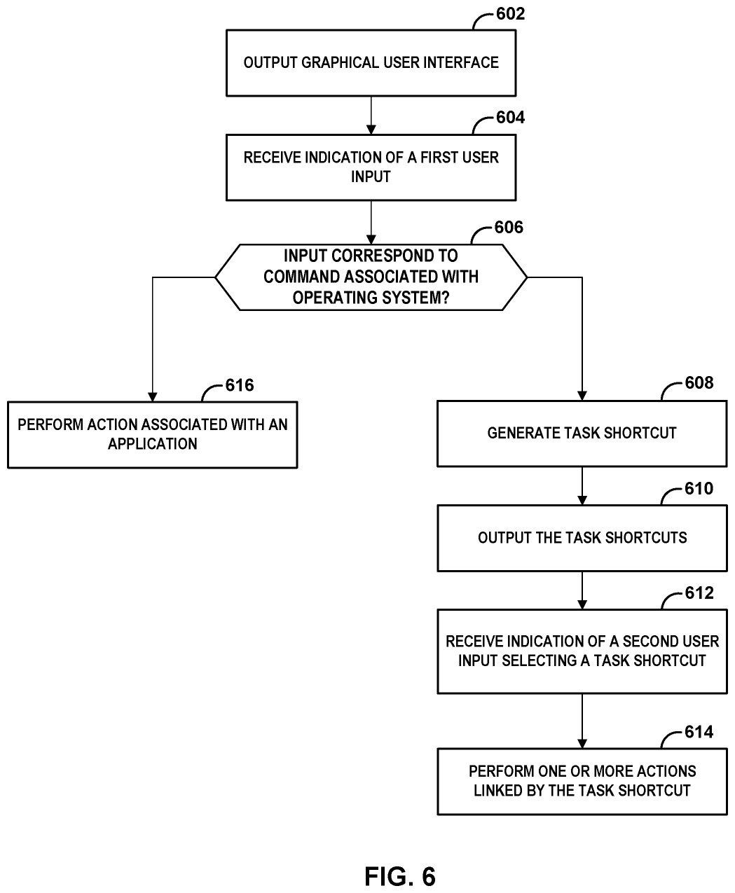

FIG. 6 is a flowchart illustrating example operations performed by an example computing device, such as computing device 100 of FIG. 1A or computing device 200 of FIG. 2, that is configured to dynamically generate task shortcuts, in accordance with one or more aspects of the present disclosure. FIG. 6 is described below in the context of computing device 100 and GUIs 120A-102C of FIGS. 1A-1C.

Computing device 100 may output a graphical user interface (e.g., GUI 120A) for display at presence-sensitive display 140 (602). The graphical user interface may include an application information region 122 and an operating system region 124. Application information region 122 includes application information associated with an application currently executing by computing device 100, such as in internet browsing application. Operating system region 124 includes operating system graphical elements 126A-C (e.g., a “back” icon, “home” icon”, and “task-switching” icon, respectively).

Presence-sensitive display 140 may detect a first user input at a location of presence-sensitive display 140 associated with one of operating system graphical elements 126 and output an indication of the first user input. Input processing module 153 of operating system 150 may receive the indication of user input.

Input processing module 153 may determine whether the first user input corresponds to a command associated with operating system 150 (604). For example, input processing module 153 may determine whether the first user input corresponds to an OS command based on a type of the user input, contextual information, or both.

Responsive to determining that the input does not correspond to a command associated with operating system 150 (“NO” path of 606), in some examples, computing device 100 may perform an action associated with an application represented by the current graphical user interface (616). For example, input processing module 153 may determine the input corresponds to a selection of a link displayed by the internet browsing application graphical user interface and UI module 152 may send a notification to the internet browsing application indicating the selection of the link.

Responsive to determining that the input corresponds to a command associated with operating system 150 (“YES” path of 606), task prediction module 154 may generate one or more task shortcuts (608). For example, task prediction module 154 may determine or predict one or more tasks the user is likely to perform and generate one or more respective task shortcuts. Task prediction module 154 may predict the one or more tasks the user is likely to perform based at least in part on application information displayed by graphical user interface 120A, contextual information, or both.

UI module 152 of operating system 150 may output graphical user interface information indicative of the task shortcuts (610). For example, UI module 152 may output the graphical user interface information to a display buffer, such that PSD 140 may display graphical user interface 120B illustrated in FIG. 1B. For example, graphical user interface 120B includes task shortcut graphical element 128A representative of a task shortcut to shop for hiking gear and task shortcut graphical element 128B representative of a task shortcut to book a trip.

Presence-sensitive display 140 may detect a second user input (e.g., a second gesture) and may provide an indication of the second user input to computing device 100. Input processing module 153 may receiving the indication of the second user input (612). Responsive to receiving the indication of the second user input, input processing module 153 may determine the second user input corresponds to a selection of a particular task shortcut graphical element (e.g., graphical element 128B).

Responsive to receiving an indication of the selection of task shortcut graphical element 128B, computing device 100 may perform one or more actions linked by the selected task shortcut (614). For example, UI module 152 may execute the application associated with task shortcut graphical element 128B. For example, UI module 152 may execute travel agent application module 156B and may send the task shortcut parameters associated with task shortcut graphical element 128B to travel agent application module 156B. Travel agent application module 156B may send, to UI module 152, information indicative of a graphical user interface 120C associated with travel agent application module 156B. UI module 152 may send the information indicative of graphical user interface 120C to the frame buffer. PSD 140 may retrieve the information indicative of graphical user interface 120C from the frame buffer and display graphical user interface 120C. As illustrated in FIG. 1C, graphical user interface 120C includes a destination field that is prepopulated based on the application information displayed in graphical user interface 120B. In other words, in some examples, the destination field of graphical user interface 120C is prepopulated with the city “El Chalten.”

The following numbered examples may illustrate one or more aspects of the disclosure:

### Example 1

A method comprising: outputting, by a computing device and for display at a presence-sensitive display device, a first graphical user interface including application information associated with a particular application of a plurality of applications executable by the computing device; receiving, by the computing device and from the presence-sensitive display device, an indication of a user input corresponding to a command associated with an operating system; responsive to receiving the indication of the user input, generating, by the computing device, based at least in part on the application information displayed as part of the first graphical user interface, at least one task shortcut to an action performable by one or more respective applications of the plurality of applications executable by the computing device; and outputting, by the computing device, for display by the display device, a second graphical user interface including a graphical element corresponding to the at least one task shortcut.

### Example 2

The method of example 1, wherein the command associated with the operating system includes a command to display indications of one or more suspended applications.

### Example 3

The method of example 1, wherein the command associated with the operating system includes a command to display a home screen generated by the operating system.

### Example 4

The method of any one of examples 1-3, wherein the graphical element corresponding to the at least one task shortcut is a second graphical element, and wherein the first input corresponds to a selection of a first graphical element of the first graphical user interface, the first graphical element associated with an operation executable by the operating system rather than an operation executable by the particular application.

### Example 5

The method of example 1, wherein the user input includes a gesture initiated at a predetermined location of the display device and terminating at a different location of the display device, wherein the gesture corresponds to a command to display graphical indications of one or more respective suspended applications or display a home screen generated by the operating system.

### Example 6

The method of example 5, wherein the different location of the display device corresponds to a lockscreen notification that is associated with a second application of the plurality of applications executable by the computing device, and wherein a first region of the second graphical user interface includes the application information associated with the second application and a second region of the second graphical user interface includes the at least one task shortcut.

### Example 7

The method of example 6, wherein the user input is a first user input, the method further comprising: responsive to receiving an indication of a second user input selecting a particular task short cut of the at least one task shortcut, outputting, by the computing device, for display by the display device, a third graphical user interface that includes at least a portion of the application information associated with the second application and application information associated with a third application that is associated with the particular task shortcut.

### Example 8

The method of any one of examples 1-7, wherein the at least one task shortcut includes a first task shortcut corresponding to a first application of the plurality of applications and a second task shortcut corresponding to a second application of the plurality of applications, wherein the second graphical user interface includes a first graphical element corresponding to the first task shortcut and a second graphical element corresponding to the second task shortcut.

### Example 9

The method of any one of examples 1-6, wherein the user input is a first user input, further comprising: receiving, by the computing device, an indication of a second user input corresponding to a selection of a particular graphical element corresponding to a particular task shortcut from the at least one task shortcuts; and performing, by the computing device, an action corresponding to the particular task shortcut.

### Example 10

A computing device comprising: one or more processors; a presence-sensitive display device; and a storage device that stores one or more modules executable by the one or more processors to: output, for display at the presence-sensitive display device, a first graphical user interface including application information associated with a particular application of a plurality of applications executable by the computing device; receive, from the presence-sensitive display device, an indication of a user input corresponding to a command associated with an operating system; responsive to receiving the indication of the user input, generate, based at least in part on the application information displayed as part of the first graphical user interface, at least one task shortcut to an action performable by one or more respective applications of the plurality of applications executable by the computing device; and output, for display by the display device, a second graphical user interface including a graphical element corresponding to the at least one task shortcut.

### Example 11

The computing device of example 10, wherein the command associated with the operating system includes a command to display indications of one or more suspended applications.

### Example 12

The computing device of example 10, wherein the command associated with the operating system includes a command to display a home screen generated by the operating system.

### Example 13

The computing device of any one of examples 10-12, wherein the graphical element corresponding to the at least one task shortcut is a second graphical element, and wherein the first input corresponds to a selection of a first graphical element of the first graphical user interface, the first graphical element associated with an operation executable by the operating system rather than an operation executable by the particular application.

### Example 14

The computing device of example 10, wherein the user input includes a gesture initiated at a predetermined location of the display device and terminating at a different location of the display device, wherein the gesture corresponds to a command to display graphical indications of one or more respective suspended applications or display a home screen generated by the operating system.

### Example 15

The computing device of example 14, wherein the different location of the display device corresponds to a lockscreen notification that is associated with a second application of the plurality of applications executable by the computing device, and wherein a first region of the second graphical user interface includes the application information associated with the second application and a second region of the second graphical user interface includes the at least one task shortcut.

### Example 16

The computing device of example 15, wherein the user input is a first user input, wherein the one or more modules are further executable by the one or more processors to: responsive to receiving an indication of a second user input selecting a particular task short cut of the at least one task shortcut, outputting, by the computing device, for display by the display device, a third graphical user interface that includes at least a portion of the application information associated with the second application and application information associated with a third application that is associated with the particular task shortcut.

### Example 17

The computing device of any one of examples 10-16, wherein the at least one task shortcut includes a first task shortcut corresponding to a first application of the plurality of applications and a second task shortcut corresponding to a second application of the plurality of applications, wherein the second graphical user interface includes a first graphical element corresponding to the first task shortcut and a second graphical element corresponding to the second task shortcut.

### Example 18

The computing device of any one of examples 10-15, wherein the user input is a first user input, wherein the one or more modules are further executable by the one or more processors to: receiving, by the computing device, an indication of a second user input corresponding to a selection of a particular graphical element corresponding to a particular task shortcut from the at least one task shortcuts; and performing, by the computing device, an action corresponding to the particular task shortcut.

### Example 19

A computer-readable storage medium comprising instructions that, when executed cause at least one processor of a computing device to: output, for display at a presence-sensitive display device, a first graphical user interface including application information associated with a particular application of a plurality of applications executable by the computing device; receive, from the presence-sensitive display device, an indication of a user input corresponding to a command associated with an operating system; responsive to receiving the indication of the user input, generate, based at least in part on the application information displayed as part of the first graphical user interface, at least one task shortcut to an action performable by one or more respective applications of the plurality of applications executable by the computing device; and output, for display by the display device, a second graphical user interface including a graphical element corresponding to the at least one task shortcut.

### Example 20

The computer-readable storage medium of example 19, wherein the command associated with the operating system includes a command to display indications of one or more suspended applications.

### Example 21

The computer-readable storage medium of example 19, wherein the command associated with the operating system includes a command to display a home screen generated by the operating system.

### Example 22

The computer-readable storage medium of any one of examples 19-21, wherein the graphical element corresponding to the at least one task shortcut is a second graphical element, and wherein the first input corresponds to a selection of a first graphical element of the first graphical user interface, the first graphical element associated with an operation executable by the operating system rather than an operation executable by the particular application.

### Example 23

The computer-readable storage medium of example 19, wherein the user input includes a gesture initiated at a predetermined location of the display device and terminating at a different location of the display device, wherein the gesture corresponds to a command to display graphical indications of one or more respective suspended applications or display a home screen generated by the operating system.

### Example 24

The computer-readable storage medium of example 23, wherein the different location of the display device corresponds to a lockscreen notification that is associated with a second application of the plurality of applications executable by the computing device, and wherein a first region of the second graphical user interface includes the application information associated with the second application and a second region of the second graphical user interface includes the at least one task shortcut.

### Example 25

The computer-readable storage medium of example 24, wherein the user input is a first user input, wherein the instructions further cause the at least one processor to: responsive to receiving an indication of a second user input selecting a particular task short cut of the at least one task shortcut, output, for display by the display device, a third graphical user interface that includes at least a portion of the application information associated with the second application and application information associated with a third application that is associated with the particular task shortcut.

### Example 26

The computer-readable storage medium of any one of examples 19-25, wherein the at least one task shortcut includes a first task shortcut corresponding to a first application of the plurality of applications and a second task shortcut corresponding to a second application of the plurality of applications, wherein the second graphical user interface includes a first graphical element corresponding to the first task shortcut and a second graphical element corresponding to the second task shortcut.

### Example 27

The computer-readable storage medium of any one of examples 19-24, wherein the user input is a first user input, wherein the instructions further cause the at least one processor to: receive an indication of a second user input corresponding to a selection of a particular graphical element corresponding to a particular task shortcut from the at least one task shortcuts; and perform, an action corresponding to the particular task shortcut.

### Example 28

A computing device comprising means for performing the methods of any of examples 1-9.

In one or more examples, the functions described may be implemented in hardware, hardware and software, hardware and firmware, or any combination thereof. If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

1-13. (canceled)

14. A method comprising:
outputting, by a computing device and for display at a presence-sensitive display device, a first graphical user interface including application information associated with a particular application of a plurality of applications executable by the computing device;
receiving, by the computing device and from the presence-sensitive display device, an indication of a user input corresponding to a command associated with an operating system;
responsive to receiving the indication of the user input, generating, by the computing device, based at least in part on the application information displayed as part of the first graphical user interface, at least one task shortcut to an action performable by one or more respective applications of the plurality of applications executable by the computing device; and
outputting, by the computing device, for display by the display device, a second graphical user interface including a graphical element corresponding to the at least one task shortcut.

15. The method of claim 14, wherein the command associated with the operating system includes a command to display indications of one or more suspended applications.

16. The method of claim 14, wherein the command associated with the operating system includes a command to display a home screen generated by the operating system.

17. The method of claim 14,
wherein the graphical element corresponding to the at least one task shortcut is a second graphical element, and
wherein the first input corresponds to a selection of a first graphical element of the first graphical user interface, the first graphical element associated with an operation executable by the operating system rather than an operation executable by the particular application.

18. The method of claim 14,
wherein the user input includes a gesture initiated at a predetermined location of the display device and terminating at a different location of the display device,
wherein the gesture corresponds to a command to display graphical indications of one or more respective suspended applications or display a home screen generated by the operating system.

19. The method of claim 18, wherein the different location of the display device corresponds to a lockscreen notification that is associated with a second application of the plurality of applications executable by the computing device, and wherein a first region of the second graphical user interface includes the application information associated with the second application and a second region of the second graphical user interface includes the at least one task shortcut.

20. The method of claim 19, wherein the user input is a first user input, the method further comprising:
responsive to receiving an indication of a second user input selecting a particular task short cut of the at least one task shortcut, outputting, by the computing device, for display by the display device, a third graphical user interface that includes at least a portion of the application information associated with the second application and application information associated with a third application that is associated with the particular task shortcut.

21. The method of claim 14,
wherein the at least one task shortcut includes a first task shortcut corresponding to a first application of the plurality of applications and a second task shortcut corresponding to a second application of the plurality of applications,
wherein the second graphical user interface includes a first graphical element corresponding to the first task shortcut and a second graphical element corresponding to the second task shortcut.

22. The method of claim 14, wherein the user input is a first user input, further comprising:
receiving, by the computing device, an indication of a second user input corresponding to a selection of a particular graphical element corresponding to a particular task shortcut from the at least one task shortcuts; and
performing, by the computing device, an action corresponding to the particular task shortcut.

23. A computing device comprising:
one or more processors;
a presence-sensitive display device; and
a storage device that stores instructions that, when executed by the one or more processors, cause the one or more processors to:
output, for display at the presence-sensitive display device, a first graphical user interface including application information associated with a particular application of a plurality of applications executable by the computing device;
receive, from the presence-sensitive display device, an indication of a user input corresponding to a command associated with an operating system;
responsive to receiving the indication of the user input, generate, based at least in part on the application information displayed as part of the first graphical user interface, at least one task shortcut to an action performable by one or more respective applications of the plurality of applications executable by the computing device; and
output, for display by the display device, a second graphical user interface including a graphical element corresponding to the at least one task shortcut.

24. The computing device of claim 23, wherein the command associated with the operating system includes a command to display indications of one or more suspended applications.

25. The computing device of claim 23, wherein the command associated with the operating system includes a command to display a home screen generated by the operating system.

26. The computing device of claim 23,
wherein the graphical element corresponding to the at least one task shortcut is a second graphical element, and
wherein the first input corresponds to a selection of a first graphical element of the first graphical user interface, the first graphical element associated with an operation executable by the operating system rather than an operation executable by the particular application.

27. The computing device of claim 23,
wherein the user input includes a gesture initiated at a predetermined location of the display device and terminating at a different location of the display device,
wherein the gesture corresponds to a command to display graphical indications of one or more respective suspended applications or display a home screen generated by the operating system.

28. The computing device of claim 27, wherein the different location of the display device corresponds to a lockscreen notification that is associated with a second application of the plurality of applications executable by the computing device, and wherein a first region of the second graphical user interface includes the application information associated with the second application and a second region of the second graphical user interface includes the at least one task shortcut.

29. The computing device of claim 28, wherein the user input is a first user input, wherein execution of the instructions further cause the at least one processor to:
responsive to receiving an indication of a second user input selecting a particular task short cut of the at least one task shortcut, output, for display by the display device, a third graphical user interface that includes at least a portion of the application information associated with the second application and application information associated with a third application that is associated with the particular task shortcut.

30. The computing device of claim 23,
wherein the at least one task shortcut includes a first task shortcut corresponding to a first application of the plurality of applications and a second task shortcut corresponding to a second application of the plurality of applications,
wherein the second graphical user interface includes a first graphical element corresponding to the first task shortcut and a second graphical element corresponding to the second task shortcut.

31. The computing device of claim 23, wherein the user input is a first user input, and wherein execution of the instructions further cause the at least one processor to:
receive an indication of a second user input corresponding to a selection of a particular graphical element corresponding to a particular task shortcut from the at least one task shortcuts; and
perform an action corresponding to the particular task shortcut.

32. A computer-readable storage medium encoded with instructions that, when executed, cause one or more processors of a computing device to:
output, for display at the presence-sensitive display device, a first graphical user interface including application information associated with a particular application of a plurality of applications executable by the computing device;
receive, from the presence-sensitive display device, an indication of a user input corresponding to a command associated with an operating system;
responsive to receiving the indication of the user input, generate, based at least in part on the application information displayed as part of the first graphical user interface, at least one task shortcut to an action performable by one or more respective applications of the plurality of applications executable by the computing device; and
output, for display by the display device, a second graphical user interface including a graphical element corresponding to the at least one task shortcut.

33. The computer-readable storage medium of claim 32, wherein the command associated with the operating system includes one of:
a command to display indications of one or more suspended applications, or
a command to display a home screen generated by the operating system.
